(19) United States
(12) Patent Application Publication
(10) Pub. No.: US 2016/0366466 A1
(43) Pub. Date: Dec. 15, 2016

(54) METHOD FOR DISPLAYING BULLET SCREEN OF VIDEO, AND ELECTRONIC DEVICE

(71) Applicant: Le Holdings(Beijing)Co., Ltd., Beijing (CN)

(72) Inventors: Fei Shen, Beijing (CN); Linhu Wang, Beijing (CN); Lingfei Kong, Beijing (CN)

(21) Appl. No.: 15/246,229

(22) Filed: Aug. 24, 2016

Related U.S. Application Data
(63) Continuation of application No. PCT/CN2015/083486, filed on Jul. 7, 2015.

(30) Foreign Application Priority Data
Jul. 7, 2014 (CN) 201410320751.1
Jul. 7, 2014 (CN) 201410321272.1

(51) Int. Cl. H04N 21/431; G06F 9/44; H04N 21/4788

(52) U.S. Cl. CPC H04N 21/4316; H04N 21/4788; G06F 9/4443

(57) ABSTRACT

The present application discloses a method for displaying a bullet screen of a video, an electronic device and a non-transitory computer-readable storage medium, wherein the method includes: creating a bullet screen layer including a transparent data layer and a transparent view layer between a video presentation layer and a user interface operating layer of the player, where the data layer is used for displaying characters, and the view layer is used for displaying images; dividing acquired bullet screen data of the current playing video into a character bullet screen and an image bullet screen according to class identifiers included in the bullet screen data; and sending the read character bullet screen to the data layer for display and the read image bullet screen to the view layer for display.

### CROSS REFERENCE TO RELATED APPLICATIONS

This application is a continuation of International Application No. PCT/CN2015/083486, filed on Jul. 7, 2015, which is based upon and claims priority to Chinese Patent Application No. 201410321272.1, filed on Jul. 7, 2014, and Chinese Patent Application No. 201410320751.1, filed on Jul. 7, 2014 the entire contents of which are incorporated herein by reference.

### TECHNICAL FIELD

The present application relates to the field of an Internet video technology, in particular to a method for displaying a bullet screen of a video, electronic device and non-transitory computer-readable storage medium.

### BACKGROUND

With the development of the Internet video technology, a video player has a bullet screen function. Through the bullet screen function, a user may see comments, made by other users who have watched a current video screen displayed, on the current video screen while watching the video on the Internet, and meanwhile may make comments on the current video screen and display his/her own comments made on the current video screen in real time.

The above-mentioned bullet screens are relevant comments that are made on the video screen at the same time point, involving the same topic in most situations, therefore, the purpose of enhancing the interactivity between the users watching the video can be realized.

However, with the aforesaid bullet screen function, bullet screens can be sent only in the form of character and due to such monotonous expression, the video viewers' moods when watching the video or opinions about the current video screen cannot be expressed vividly and iconically. It is thus clear that the current bullet screen displaying of videos has the problems of monotonous expression and inability to further improve the interactivity between the users watching the video.

### SUMMARY

An embodiment of the present application provides a method for displaying a bullet screen of a video, an electronic device and a non-transitory computer-readable storage medium to solve the problems of the current bullet screen displaying of videos in the prior art, including monotonous expression and inability to further improve the interactivity between the users watching the video.

The specific technical solution provided by an embodiment of the present application is presented as follows:

a method for displaying a bullet screen of a video, includes:

creating a bullet screen layer including a transparent data layer and a transparent view layer between a video presentation layer of a video player and a user interface operating layer of the player, where the data layer is used for displaying a character, and the view layer is used for displaying an image;

dividing acquired bullet screen data of the currently played video into a character bullet screen and an image bullet screen according to class identifiers included in the bullet screen data; and

sending the read character bullet screen to the data layer for display and the read image bullet screen to the view layer for display.

An electronic device, includes:

an image layer creating module, configured to create a bullet screen layer including a transparent data layer and a transparent view layer between a video presentation layer of a video player and a user interface operating layer of the player, where the data layer is used for displaying characters, and the view layer is used for displaying images;

a bullet screen data classification module, configured to divide acquired bullet screen data of the currently played video into a character bullet screen and an image bullet screen according to class identifiers included in the bullet screen data; and

a display module, configured to send the read character bullet screen to the data layer for display and the read image bullet screen to the view layer for display.

A non-transitory computer-readable storage medium storing executable instructions that, when executed by an electronic device with a touch-sensitive display, cause the electronic device to:

create a bullet screen layer including a transparent data layer and a transparent view layer between a video presentation layer of a video player and a user interface operating layer of the player, wherein the data layer is used for displaying characters, and the view layer is used for displaying images;

divide acquired bullet screen data of the currently played video into a character bullet screen and an image bullet screen according to the class identifiers included in the bullet screen data; and

send the read character bullet screen to the data layer for display and the read image bullet screen to the view layer for display.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic structural diagram of a layer included in a video player of the prior art according to some embodiments of the application;

FIG. 2 is a flow chart of a displaying method for a bullet screen of a video according to some embodiments of the application;

FIG. 3 is a schematic structural diagram of the layer included in the video player according to some embodiments of the application;

FIG. 4 is a flow chart of a displaying method for a bullet screen of a video according to some embodiments of the application;

FIG. 5 is a flow chart of a displaying method for a bullet screen of a video according to some embodiments of the application;

FIG. 6 is a schematic structural diagram of a layer included in a video player according to some embodiments of the application;

FIG. 7 is a schematic structural diagram of an electronic device according to some embodiments of the application;

FIG. 8 is a flow chart of a displaying method for a bullet screen of a video according to some embodiments of the application; and

FIG. 9 is a schematic structural diagram of an electronic device according to some embodiments of the application.

### DETAILED DESCRIPTION

An embodiment of the present application provides a method for displaying a bullet screen, an electronic device and a non-transitory computer-readable storage medium to solve the problems of the bullet screen display of the current video in the prior art, including monotonous expression as well as the inability to further improve the interactivity between the users watching the video.

For a better understanding of the solution of the present application, the layers included in an existing player are depicted first:

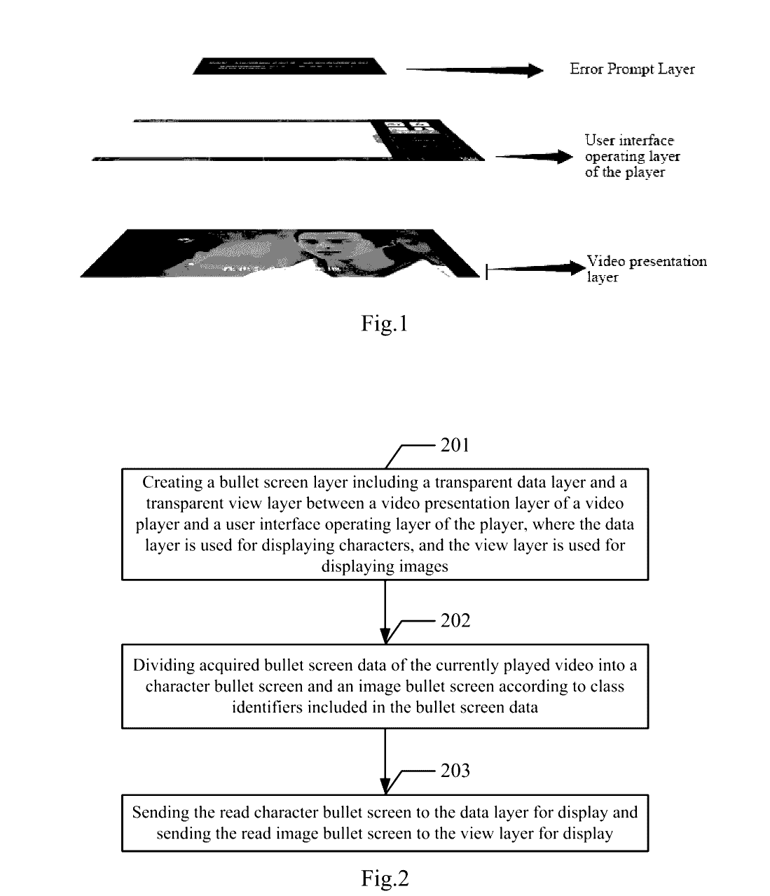

Layers of the player can be considered as transparent containers in which elements of any object can be placed arbitrary, where the layers are completely independence with each other and have a stacking order, and thus an object in a lower layer may be obscured by an object in an upper layer. FIG. 1 shows the layers typically included in the existing player, that is, a video presentation layer, a user interface operating layer of the player and an error prompt layer, in a sequence from top to bottom; where the video presentation layer is used for displaying video pictures, the user interface operating layer of the player is a layer which provides the user with direct interaction with the player, and the error prompt layer is used for promoting a playing error occurred.

Embodiments of the present application will be further depicted below in combination with the figures.

As illustrated in FIG. 2, there is a displaying method for a bullet screen of a video according to an embodiment of the application, where the method includes the following steps:

In step 201, a bullet screen layer including a transparent data layer and a transparent view layer is created between a video presentation layer of a video player and a user interface operating layer of the player, where the data layer is used for displaying characters, and the view layer is used for displaying images.

In the step 201, there are two creation schemes:

A first scheme: firstly, the transparent view layer is created between the video presentation layer of the video player and the user interface operating layer of the player; then, the transparent data layer is created between the created view layer and the user interface operating layer of the player; and

A second scheme: firstly, the transparent data layer is created between the video presentation layer of the video player and the user interface operating layer of the player; then, the transparent view layer is created between the created view layer and the user interface operating layer of the player.

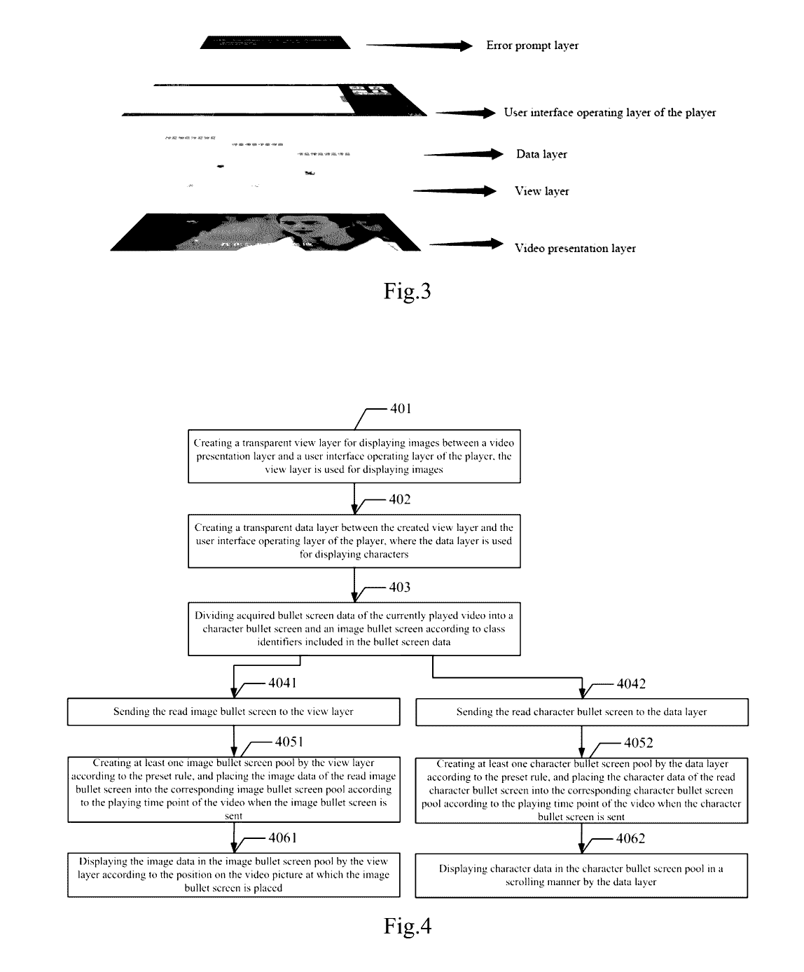

With regard to the second scheme, after the data layer and the view layer are created, the layers of the player is shown in FIG. 3, that is, the video presentation layer, the view layer, the data layer, the user interface operating layer of the player and the error prompt layer, sequentially from bottom to top; where the bullet screen layer consists of the view layer and the data layer.

In step 202, acquired bullet screen data of the currently played video are divided into a character bullet screen and an image bullet screen according to class identifiers included in the bullet screen data.

The bullet screen data may be acquired from a bullet screen data server, for instance, when the video is opened, the video player sends a bullet screen data request with a video identifier to the bullet screen data server; after receiving the bullet screen data request, the bullet screen data server uses the video identifier carried therein to search for the bullet screen data of the video indicated by the identifier in a local data base, and returns the found bullet screen data to the video player.

The bullet screen data may be a bullet screen including newest bullet screens acquired from the bullet screen data server in real time by the video player, for instance, a bullet screen data request is sent to the bullet screen server at a set time interval, and the previous bullet screen data is updated by this currently received bullet screen data; the bullet screen data may also be a bullet screen acquired from the bullet screen data server previously but not updated during playback of the video.

The bullet screen data in step 202 includes a bullet screen whose class identifiers are character and a bullet screen whose class identifiers are image. By executing the step 202, the acquired bullet screen data of the current video may be divided into the character bullet screen and the image bullet screen according to the class identifiers.

The image bullet screen includes an expression bullet screen which is in the form of image.

In step 203, the read character bullet screen is sent to the data layer for display and the read image bullet screen is sent to the view layer for display.

In the solution provided by the embodiment of the present application, firstly, the bullet screen layer including the transparent data layer and the transparent view layer is created between the video presentation layer of the video player and the user interface operating layer of the player; secondly, acquired bullet screen data is divided into the image bullet screen and the character bullet screen; and lastly, the read character bullet screen is sent to the data layer for display and the read image bullet screen to the view layer for display, so as to realize jointly displaying the character bullet screen and the newly increased image bullet screen. On the basis of the existing character bullet screen, the image bullet screen is newly added and displayed between the video presentation layer and the user interface operating layer of the layer. As a consequence, expression and display modes of the bullet screen can be diversified, the video viewers' moods when they are watching the video and opinions for the current video screen can be expressed vividly and iconically, and the interactivity between the users watching the video can be improved. In addition, the solution of the present application according to the embodiment can be optimized to further improve the interactivity between the users. With a embodiment, the following will depict the optimized solution of the present application of the embodiment.

Another embodiment of the present application provides a displaying method for a bullet screen of a video, the flow chart of which is shown in FIG. 4, includes:

In step 401, a transparent view layer for displaying images is created between a video presentation layer and a user interface operating layer of the player, the view layer is used for displaying images, and then step 402 is executed.

In step 402, a transparent data layer is created between the created view layer and the user interface operating layer of the player, where the data layer is used for displaying characters; and then step 403 is executed.

In step 403, acquired bullet screen data of the currently played video are divided into a character bullet screen and an image bullet screen according to class identifiers included in the bullet screen data, and then step 4041 and step 4042 are executed.

The image bullet screen includes image data, the playing time point of the video when the image bullet screen is sent and the position on the video picture where the image bullet screen is placed.

The character bullet screen includes: character data and the playing time point of the video when the character bullet screen is sent.

In step 4041, the read image bullet screen is sent to the view layer, and then step 4051 is executed.

In step 4051, at least one image bullet screen pool is created by the view layer according to the preset rule, and the image data of the read image bullet screen are placed into the corresponding image bullet screen pool according to the playing time point of the video when the image bullet screen is sent, and then step 4061 is executed.

The preset rule may be an image bullet screen pool corresponding to a video time segment which is created according to the video time segment. In this case, the playing time point of the video at which a image bullet screen in the image bullet screen pool is sent fall within the video time segment corresponding to the image bullet screen pool, which may be the image bullet screen pool corresponding to a video time segment which is created by dividing the playing time length of the video at an even interval or may be a video bullet screen pool corresponding to a video segment which is created by dividing the playing time length of the video at an un-even interval depending on the contents of the video. In the case of dividing the time length at an un-even interval, division can be conducted according to the time length of playing each scene of the video or the hot time segment of the video. A scene refers to a set of successive camera shots taken at single place. If the division is conducted according to the hot time segment of the video, the hot time segment of the video may be acquired from the bullet screen data server, the bullet screen data server may make statistics on the number of entries of bullet screen data within the video time segment as well as operations of the user, such as fast forward, fast backward and replaying, so as to determine whether the video time segment is a hot time segment of the video.

By way of example, the following will illustrate the division of the video time segment and the image bullet screen pool corresponding to the video time segment.

For instance, it is supposed that the length of the current video is 10 s and the time segment is divided at an interval of every 2 s (i.e., dividing at an even interval), the time length of the current video may be divided into 5 video time segments: the first video time segment ranges from greater than 0 s to less than or equal to 2 s; the second video time segment ranges from greater than 2 s to less than or equal to 4 s; the third video time segment ranges from greater than 4 s to less than or equal to 6 s; the fourth video time segment ranges from greater than 6 s to less than 8 s; and the fifth video time segment ranges form greater than 8 s to less than or equal to 10 s.

If the current playing time point of the currently played video is 3 s which is greater than 2 s and less than or equal to 4 s, the current playing time point of the currently played video falls within the second video time segment; in the case, the playing time point of the video at which the image bullet screen, in the corresponding image bullet screen pool, is sent, falls within this time range which is greater than 2 s and less than or equal to 4 s.

If the current video with the above-described length of 10 s includes three scenes, and the time length of the first scene is 5 s, the time length of the second scene is 3 s and the time length of the third scene is 2 s, the current video time length may be divided into three video time segments: the first video time segment ranges from greater than 0 s to less than or equal to 5 s, the second video time segment ranges from greater than 5 s to less than or equal to 8 s, and the third video time segment ranges from greater than 8 s to less than or equal to 10 s.

In step 4061, the image data in the image bullet screen pool are displayed by the view layer according to the position on the video picture at which the image bullet screen is placed.

In step 4042, the read character bullet screen is sent to the data layer, and then step 4052 is executed.

In step 4052, at least one character bullet screen pool is created by the data layer according to the preset rule, and the character data of the read character bullet screen is placed into the corresponding character bullet screen pool according to the playing time point of the video when the character bullet screen is sent, and then step 4062 is executed.

The preset rule in the step 4052 is similar to that in the step 4051, which will not be presented repeatedly herein.

In step 4062, character data in the character bullet screen pool is displayed in a scrolling manner by the data layer.

In the embodiment of the present application, the image bullet screen and the character bullet screen are displayed by a structure of the layers included in the player as shown in FIG. 3. This is because the image bullet screen is displayed in the view layer according to the position at which the image bullet screen is placed and the character bullet screen is displayed in a scrolling manner; and during the presentation according to the structure as shown in FIG. 3, the image bullet screen may not obscure the character bullet screen and as the character bullet screen is displayed in a scrolling manner, the image bullet screen can be visible at the interval of scrolling, thereby improving the readability of the bullet screen data.

In the solution of the present application according to the embodiment, the image bullet screen is displayed in the transparent view layer above the video presentation layer according to the position on the video picture at which the image bullet screen is placed, and the character bullet screen is displayed in a scrolling manner in the transparent data layer above the view layer, so the display mode of the bullet screen can be diversified, the number of entries of bullet screen data (the character bullet screen and the image bullet screen) displayed at the same time can be increased, and the interactivity between the users can be improved.

In addition, the solution of the present application according to the embodiment can be further optimized to further improve the interactivity between the users. With an embodiment, the following will depict the optimized solution of the present application of the embodiment.

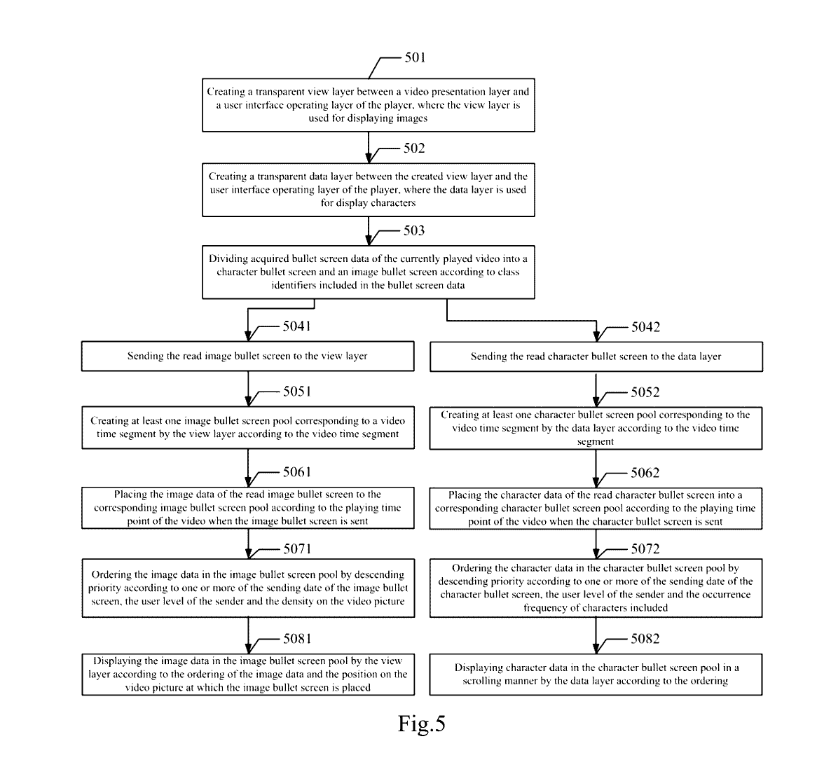

Another embodiment of the present application provides a displaying method for a bullet screen of a video, the flow chart of which is shown in FIG. 5, includes:

In step 501, a transparent view layer is created between a video presentation layer and a user interface operating layer of the player, where the view layer is used for displaying images, and then step 502 is executed.

In step 502, a transparent data layer is created between the created view layer and the user interface operating layer of the player, where the data layer is used for display characters; and then step 403 is executed.

In step 503, acquired bullet screen data of the currently played video are divided into a character bullet screen and an image bullet screen according to class identifiers included in the bullet screen data, and then step 5041 and step 5042 are executed.

The image bullet screen includes image data, the playing time point of the video when the image bullet screen is sent, and the position on a video picture at which the image bullet screen is placed, the sending date of the image bullet screen, a user level of the sender and the density on video screen.

The character bullet screen includes: character data, the playing time point of the video when the character bullet screen is sent, the sending date of the character bullet screen, a user level of the sender and the occurrence frequency of characters included; and the occurrence frequency refers to the frequency at which the included characters occurs in all bullet screen data of the video.

In step 5041, the read image bullet screen is sent to the view layer, and then step 5051 is executed.

In step 5051, at least one image bullet screen pool corresponding to a video time segment is created by the view layer according to the video time segment, and then step 5061 is executed.

In the case, the playing time length of the video is divided to obtain a series of video time segments according to the preset division rule.

In step 5061, the image data of the read image bullet screen is placed to the corresponding image bullet screen pool according to the playing time point of the video when the image bullet screen is sent, and then step 5071 is executed.

In step 5071, for the view layer, the image data in the image bullet screen pool are ordered by descending priority according to one or more of the sending date of the image bullet screen, the user level of the sender and the density on the video picture, and then step 5081 is executed.

The above ordering may also be called ordering by priority, the priorities of the image data may be set in such manner that the image bullet screen with the earlier sending date results in higher priority of the image data in the image bullet screen, and the image bullet screen with the later sending date results in the lower priority; the image bullet screen with the higher user level of the sender results in the higher priority, and the image bullet screen with lower user level of the sender results in the lower priority; and the image bullet screen with the lower density on the video screen results in the higher priority, and the image bullet screen with lower density on the video screen results in the lower priority.

The density of image bullet screens on video pictures may be counted and sent to the video player by the bullet screen server.

In step 5081, the image data in the image bullet screen pool are displayed by the view layer according to the ordering of the image data and the position on the video picture at which the image bullet screen is placed.

Preferably, before step 5041, a video pixel value of the currently played video may be acquired as well, and the number of entries M1 of the image data which are displayable during playback of the current video may be determined according to the correspondence between the stored video pixel value and the number of entries of displayable image data.

After the step 5071 and before the step 5081, at most M1 entries of the image data is selected from the image bullet screen pool according to the priority ordering, and in the step 5081, the view layer can display the selected image data according to the position on the video picture at which the image bullet screen is placed.

Because in the above step 5071, the image data are selected according to the priority ordering and the image data with higher priority are more possibly selected, the possibility of the displayed image data with high quality is relatively higher when the view layer may display the selected image data according to the position on the video picture at which the image bullet screen is placed, that is to say, the role of shielding some meaningless or slightly significant image bullet screens can be played, and the interactivity between the users can be further improved.

In consideration of those image data which are not selected in the image bullet screen pool and thus those image data which are not selected cannot be displayed, to provide those image data which are not selected with the chance of being displayed and allow the current user to see those image data which are not selected, and further improve the interactivity between the users, preferably, the method further includes: marking the displayed image data as displayed.

In the case, when the aforesaid image data is selected by the current user, at most M1 entries of image data are selected from the image data which are not marked as displayed in the image bullet screen pool, according to the ordering of the image data.

Through the above-mentioned preferred solution, when the current user watches the video repeatedly, at the same playing time point, the displayed image data seen this time differs from the displayed image data seen last time.

In step 5042, the read character bullet screen is sent to the data layer, and then step 5052 is executed.

In step 5052, at least one character bullet screen pool corresponding to the video time segment is created by the data layer according to the video time segment, and then step 5062 is executed.

In step 5062, the character data of the read character bullet screen is placed into a corresponding character bullet screen pool according to the playing time point of the video when the character bullet screen is sent, and then step 5062 is executed.

In step 5072, for the data layer, the character data in the character bullet screen pool is ordered by descending priority according to one or more of the sending date of the character bullet screen, the user level of the sender and the occurrence frequency of characters included, and then step 5082 is executed.

The priority ordering of the character data in the step 5072 is similar to that of the image data in the image bullet screen pool, which will not be presented repeatedly here.

In step 5082, character data in the character bullet screen pool are displayed in a scrolling manner by the data layer according to the ordering.

Preferably, before the step 5042, the video pixel value of the video may be acquired, and at most M2 entries of image data which may be displayable during playback of the current video can be determined according to the correspondence between the video pixel value stored and the number of entries of displayable character data.

After the step 5071 and before the step 5081, at most M2 entries of character data is selected from the image bullet screen pool according to the priority ordering, and in the step S082, the data layer may display the selected character data in a scrolling manner.

Because in the above step S071, the character data are selected according to the priority ordering and the character data with higher priority are more possibly selected, the possibility of the displayed character data with high quality is relatively higher when the view layer displays the selected character data in a scrolling manner, that is to say, the role of shielding some meaningless or slightly significant character data can be played, and the interactivity between the users can be improved.

In consideration of those character data which are not selected in the character bullet screen pool and thus those character data which are not selected cannot be displayed, to provide those character data which are not selected with the chance of being displayed and allow the current user to see those character data which are not selected, and further improve the interactivity between the users, preferably, the method further includes: marking the displayed character data as displayed.

In the case, when the aforesaid character data is selected by the current user, at most M2 entries of character data is selected from the character data which are not marked as displayed in the character bullet screen pool according to the ordering of the character data.

Through the above-mentioned preferred solution, when the current user watches the video repeatedly, at the same playing time point, the displayed character data which are seen this time differs from the displayed character data which are seen last time.

In addition, considering that a user may send bullet screen data when watching the video loaded with bullet screen data, preferably, the displaying method for the bullet screen of the video in any one of the above embodiments further includes:

receiving bullet screen data sent by the current user at the current playing time point, and recording the position on the video picture at which the image bullet screen is placed; and

setting the class identifier for the received image bullet screen as image, placing the image data in the received image bullet screens into the corresponding image bullet screen pool according to the current playing time point, and sending the received image bullet screen with the information including the video identifier of the video, a user level of the current user, the sending date, the class identifier, the current playing time point and the position placed on the video screen to a bullet screen data server.

In the case, where in the step 5081 the image data in the image bullet screen pool are displayed by the view layer, according to the ordering of the image data, at the position on the video picture at which the image bullet screen is placed, the step further includes:

for the current user, the image data in the image bullet screen pool and the image data in the received image bullet screen are displayed by the view layer, according to the ordering of the image data, at the position on the video picture at which the image bullet screen is placed.

When the current user sends the character bullet screen, preferably, the displaying method for the bullet screen of the video in any one of the above embodiments further includes:

receiving the character bullet screens sent by the current user at the current playing time; and

setting the class identifier of the received character bullet screen as characters, placing the character data in the received character bullet screens into the corresponding character bullet screen pool according to the current playing time point, and sending the received character bullet screens with the information including the video identifier of the video, the user level of the current user, the sending date, the class identifier and the current playing time point to the bullet screen data server.

In the case, where in the step S082 the character data in the character bullet screen pool are displayed in a scrolling manner by the data layer according to the ordering, includes:

for the current user, displaying, in a scrolling manner, the character data in the character bullet screen pool and the character data in the received character bullet screen by the data layer according to the ordering.

In the case, after sending the bullet screen data (the character bullet screen and/or the image bullet screen), the user can immediately see the bullet screen data (the character bullet screen and/or the image bullet screen) sent by himself on the currently played video, and the received bullet screen data (i.e. the bullet screen data sent by the current user) is displayed, and thus no matter how many times the current user repeatedly watches the video, the current user can see the bullet screen data (the character bullet screen and/or the image bullet screen) sent by himself at the same video playing time.

Preferably, to enable the image data in the image bullet screen pool to be circularly displayed, provide the user with a chance of re-watching the displayed image bullet screens, and improve the interactivity between the users, the method further includes:

when all image bullet screens in the image bullet screen pool corresponding to the video time segment are displayed, all image data in the image bullet screen are marked as not displayed.

Preferably, to enable the character data in the character bullet screen pool to be circularly displayed and provide the user a chance of re-watching the displayed character bullet screen, and improve the interactivity between the users, the method further includes:

when all character bullet screens in the character bullet screen pool corresponding to the video time segment are displayed, all character data in the character bullet screen are marked as not displayed.

Specifically, the method of sending the image bullet screen by the user may be realized by the following ways:

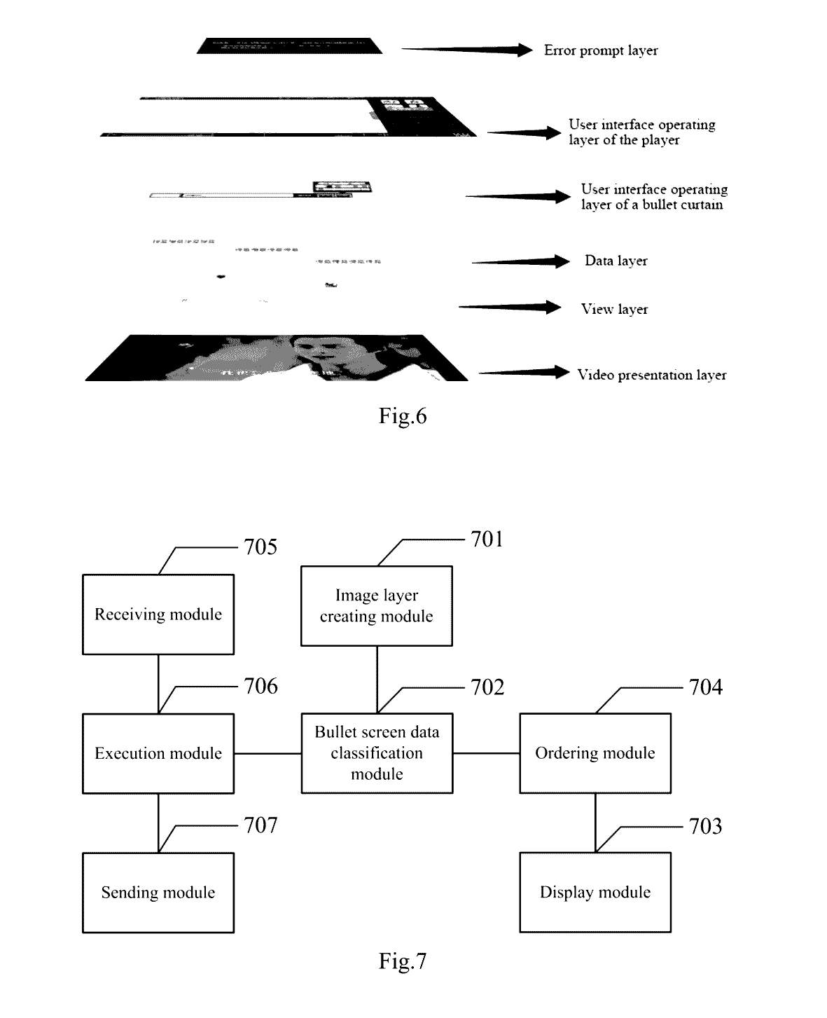

creating a user interface operating layer including the set image bullet screen between the data layer and the user interface (User Interface, UI) operating layer of the player, that is, the bullet screen layer includes the view layer, the data layer and the user interface operating layer of the bullet screen player. In the case, the schematic structural diagram of the layers included in the player is as shown in FIG. 6.

Based on the player in FIG. 6, a user may operate the user interface operating layer of the bullet screen player, drag the image bullet screen thereon, click a mouse to place bullet screen expressions on the video picture to be placed; the image bullet screen dragged by the mouse disappears when the user releases the mouse; the user interface operating layer of the bullet screen player sends data to inform the view layer of the serial number of the selected image bullet screen, the user level of the selected image bullet screen, and the position of the selected image bullet screen on the video screen played by the player (may be expressed in the form of coordinate); after receiving these information, the view layer displays the selected image dragged by the user, and sends the image bullet screen with the video identifier of the video, the user level of the current user, the sending date, the class identifier, the current playing time point and the information of the position placed on the video picture.

In the solution of the present application according to the embodiment, the image bullet screen pool and the character bullet screen pool are divided according to the video time segment, the corresponding image bullet screens and character bullet screens in the image bullet screen pool and the character bullet screen pool are ordered by priority respectively, and are displayed according to the priority ordering while being displayed, so that the image bullet screens and character bullet screens with higher priorities can be displayed preferentially, the bullet screen data with high quality can be preferentially displayed, and the interactivity between the users can be improved. Furthermore, the number of entries of the bullet screen data (inclusive of the image data and the character data) displayed on the video screen within the video time segment is limited, and at most the limited number of entries of character data and image data are selected from the ordered character bullet screen pool or the image bullet screen pool, so that the superposition of the character bullet screens displayed in a scrolling manner can be effectively prevented, the readability of the character data can be improved, and the interactivity between the users can be further improved to a greater extent.

Based on the same application concepts of the present application according to the above embodiments, another embodiment of the present application provides an electronic device, which schematic structural diagram is shown in FIG. 7, which includes: an image layer creating module 701, a bullet screen data classification module 702 and a display module 703.

The image layer creating module 701 is configured to create a bullet screen layer including a transparent data layer and a transparent view layer between a video presentation layer of a video player and a user interface operating layer of the player, where the data layer is used for displaying characters, and the view layer is used for displaying images.

The bullet screen data classification module 702 is configured to divide acquired bullet screen data of the currently played video into a character bullet screen and an image bullet screen according to class identifiers included in the bullet screen data;

The display module 703 is configured to send the read character bullet screen to the data layer for display and the read image bullet screen to the view layer for display.

Preferably, the image layer creating module 701 is specifically configured to create the transparent view layer between the video presentation layer and the user interface operating layer of the video player; create the transparent data layer between the created view layer and the user interface operating layer of the player.

Preferably, the image bullet screen includes image data, the playing time point of the video when the image bullet screen is sent, and the position on the video picture at which the image bullet screen is placed; and the character bullet screen includes: character data and the playing time point of the video when the character bullet screen is sent.

The display module 703 is specifically configured to send the read image bullet screen to the view layer; create at least one image bullet screen pool by the view layer according to the preset rule, place the image data of the read image bullet screen to the corresponding image bullet screen pool according to the playing time point of the video when the image bullet screen is sent; place the image data in the image bullet screen pool by the view layer according to the position on the video picture at which the image bullet screen is placed; send the read character bullet screen to the data layer; create at least one character bullet screen pool by the data layer according to the preset rule, and place the character data of the read character bullet screen into a corresponding character bullet screen pool according to the playing time point of the video when the character bullet screen is sent; display character data in the character bullet screen pool by the data layer in a scrolling manner.

Preferably, the image bullet screen further includes: the sending date of the image bullet screen, the user level of a sender and the density on the video picture; the character bullet screen further includes: the sending date of the character bullet screen, the user level of the sender and the occurrence frequency of characters included; the occurrence frequency refers to the frequency at which the included characters occur in all bullet screen data of the video.

The display module 703 is specifically configured to create at least one image bullet screen pool corresponding to a video time segment by the view layer according to the video time segment, where the playing time length of the video is divided to obtain a series of video time segments according to the preset division rule; and create at least one character bullet screen pool corresponding to the video time segment by the data layer according to the video time segment.

The electronic device further includes: an ordering module 704 configured to use the view layer to order image data in the image bullet screen pool by descending priority according to one or more of the sending date of the image bullet screen, the user level of the sender and the density on the video picture; use the data layer to order the character data in the character bullet screen pool by descending priority according to one or more of the sending date of the character bullet screen, the user level of the sender and the occurrence frequency of characters included.

The display module 703 is specifically configured to use the view layer to display the image data in the image bullet screen pool according to the ordering of the image data and the position on the video picture at which the image bullet screen is placed; use the data layer to display the character data in the character bullet screen pool in a scrolling manner according to the ordering.

Preferably, the electronic device further includes:

a receiving module 705 configured to receive the image bullet screen sent by the current user at the current playing time, and record the position on the video picture at which the image bullet screen is placed.

an execution module 706 configured to set the class identifier of the received image bullet screen as image, and place the image data in the received image bullet screen into the corresponding image bullet screen pool according to the current playing time; and

a sending module 707 configured to send the received image bullet screen with the information including the video identifier of the video, the user level of the current user, the sending date, the class identifier, the current playing time point and the position placed on the video picture to a bullet screen data server.

Preferably, the electronic device further includes:

a receiving module 705 configured to receive the character bullet screen sent by the current user at the current playing time;

an execution module 706 configured to set the class identifier of the received character bullet screen as character, and place the character data in the received character bullet screen into the corresponding character bullet screen pool according to the current playing time; and

a sending module 707 configured to send the received character bullet screen with the information including the video identifier of the video, the user level of the current user, the sending date, the class identifier, the current playing time point to the bullet screen data server.

It should be noted that modules of the last preferred electronic device and the next-to-last preferred electronic device have common names but different functions. The present application may also have a preferred electronic device, where the module included by the preferred electronic device is the same as the module of the last preferred electronic device with the same connection relationship, but the included receiving module, the execution module and the sending module all have the functions of the corresponding modules in the last preferred electronic device and the next-to-last preferred electronic device, which will not be depicted repeatedly here.

In addition, the solution of the present application according to the embodiment may be further optimized to further improve the interactivity between the users. With an embodiment, the following will depict the optimized optimization solution of the present application according to the embodiment.

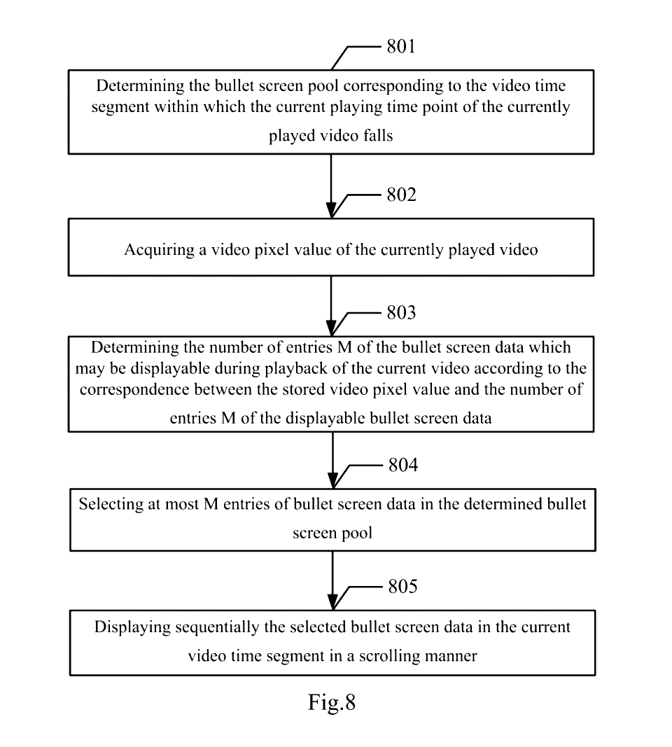

Another embodiment of the present application provides a displaying method for a bullet screen of a video, taking bullet screen data as character data for example, which flow chart is shown in FIG. 8, the method includes:

In step 801, the bullet screen pool corresponding to the video time segment within which the current playing time point of the currently played video falls is determined.

In step 802, a video pixel value of the currently played video is acquired.

In the step 802, on account of taking the greater relationship between the video pixel value of the video (a pixel value at the height is multiplied by a pixel value at the width) and the number of entries of the bullet screen data which are able to be displayed within the range of the video picture, and thus the video pixel value of the current displayed video is required to be determined in the step 802.

In step 803, the number of entries M of the bullet screen data which may be displayable during playback of the current video is determined according to the correspondence between the stored video pixel value and the number of entries M of the displayable bullet screen data.

The above-mentioned correspondence may be preset according to an empirical value. In general, the higher video pixel value of the video shows larger curtain range displayable by the video, the larger displayable size and more bullet screen data displayable on the video picture at the same time. For instance: when the pixel value of some video is 1440*1960, if the video picture and the previous picture are divided into two column, each row has the height of 128 pixels, the number of entries M of bullet screen data displayable on one frame picture is 22 when the video is played. If each row only displays one bullet screen, M is 11.

In step 804, at most M entries of bullet screen data in the determined bullet screen pool are selected.

In step 805, the selected bullet screen data in the current video time segment is sequentially displayed in a scrolling manner.

The scrolling display in the step 805 may be scrolling display at the bottom end of the video or scrolling display at the top end of the video, and may be scrolling display from one edge to the other edge of the video screen, for instance, from the left edge to the right edge of the video screen.

In the step 805, in the case of using scrolling display, on the basis of the number of pixels for actually displaying the video occupied at the height and in combination with the number of pixels occupied by the characters included in the bullet screen data at the height, the selected bullet screen data may be sequentially displayed in a scrolling manner on the video picture during the current video time segment. In addition, in the case of parallel display, the bullet screen data with the same time may be displayed at the same playing time point. The sending time is the time when the bullet screen data are sent within respective video time segments while the video is watched.

In the above-mentioned embodiment of the present application, if the current video is divided according to one video time segment every 2 s, each bullet screen data may be displayed for 3 s in the case of scrolling display, and the readability of the bullet screen data is better.

In the solution of the present application according to the above-mentioned embodiment, firstly, the bullet screen pool corresponding to the video time segment within which the current playing time point falls is determined; secondly, the number of entries of the bullet screen data which are displayable can be determined according to the video pixel value of the currently played video when the current video is played; thirdly, at most bullet screen data with the determined number of entries of bullet screen data is selected from the determined bullet screen pool; and lastly, the bullet screen data selected is displayed in a scrolling manner during the current video time segment. Because the bullet screen pool corresponding to the video time segment within which the current playing time point falls is determined and the number of entries of bullet screen data displayed during the current video time segment is reasonably limited, it is ensured that the bullet screen data is orderly displayed during the current video time segment, the possibility that no superposition occurs can be improved, and the possibility of affecting the reading of the user is relatively low, that is to say, the interactivity between the users can be improved with respect to the prior art.

Furthermore, in consideration that the character moving speed will affect the user to identify the characters while the user reads the characters, the bullet screen with more characters are more unlikely to be identified than those with fewer characters at the same moving speed. In an attempt to improve the readability of the bullet screen data, preferably, after at most M entries of the bullet screen data is selected from the determined bullet screen pool and before the selected bullet screen data is sequentially displayed in a scrolling manner during the current video time segment, preferably, the method further includes:

determining a corresponding moving speed of each entry of the selected bullet screen data according to the number of characters included in the bullet screen data; where the more characters the bullet screen data include, the slower its moving speed is;

in the case, sequentially displaying in a scrolling manner the selected bullet screen data in the current video time segment, includes:

sequentially displaying in a scrolling manner the selected bullet screen data according to the determined corresponding moving speed in the current video time segment.

By means of the further preferred solution, for the moving speed of the bullet screen data displayed in a scrolling manner is determined according to the number of characters included by the bullet screen data, the readability of the displayed bullet screen can be further improved.

Preferably, to circularly display the bullet screen data in the bullet screen pool, give the user a chance of re-watching the displayed bullet screen data and improve the interactivity between the users, the method further includes:

marking all bullet screen data as not displayed in the bullet screen pool when the bullet screen data are all displayed in the bullet screen pool corresponding to the video time segment.

With respect to the limited number of bullet screen data in the bullet screen data displayed in each video time segment in the solution of the present application according to the embodiment, a part of bullet screen data can be displayed according to the ordering, the user cannot see the rest of bullet screen data that cannot be displayed. Therefore, when the user repeatedly plays or plays back the current video, the bullet screen data not displayed is selected according to the ordering and the selected bullet screen is sequentially displayed in a scrolling manner till the bullet screen in the bullet screen pool is completely popped up and displayed once. When the user watches a 20-minute video, the user sends the bullet screen data while watching at the tenth minute of the video, watches all bullet screen data contents within the tenth minute to the twenty-th minute, and then plays back for watching; the previously displayed bullet screen data will be displayed no longer when the user plays back to the tenth minute, the bullet screen data not displayed is selected and displayed according to the priority of the bullet screen data, but the bullet screen data sent by the user will be displayed at every display, and will be displayed at the tenth minute of the video no matter how many times the user plays back.

In the solution of the present application according to the embodiment, the number of bullet screen data displayed on the video screen within the current video time segment is determined, and meanwhile the number of characters is determined according to the moving speed of the selected bullet screen data, ensuring the readability of the bullet screen data displayed in a scrolling manner from every angle, and further improving the interactivity between the users to a greater extent.

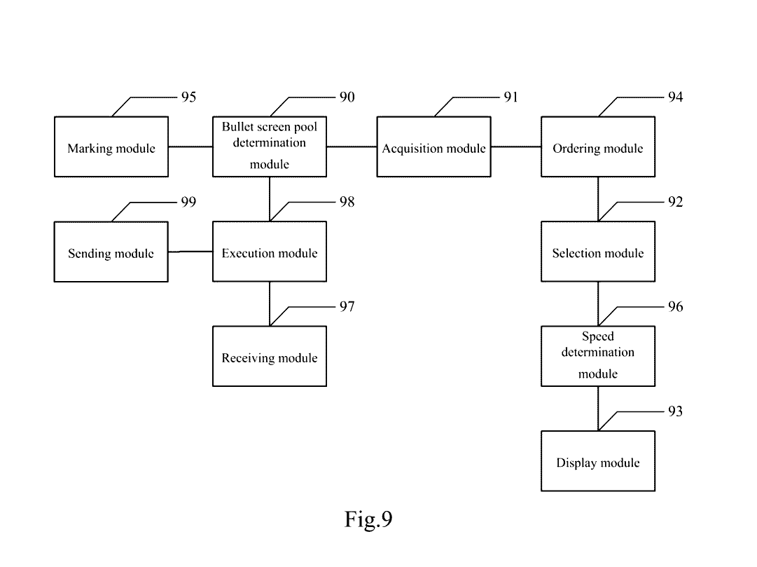

Based on the same application concept of the above-mentioned embodiment provided by the present application, another embodiment of the present application provides a displaying electronic device for a bullet screen of a video, which schematic structural diagram is shown in FIG. 9, includes: a bullet screen pool determination module 90, an acquisition module 91, a selection module 92 and a display module 93.

The bullet screen pool determination module 90 is configured to determine the bullet screen pool corresponding to the video time segment within which the current playing time point of the currently played video falls, where the playing time length of the video being divided to obtain a series of video time segments according to the preset rule; the bullet screen pool including all bullet screen data sent by the user the video within the corresponding video time segments during playback of the video.

the acquisition module 91 is configured to acquire a video pixel value of the currently played video, and determine the number of entries M of bullet screen data which are displayable during playback of the current video according to the correspondence between the stored video pixel value and the number of entries of the bullet screen data which are displayable;

the selection module 92 is configured to select at most M entries of bullet screen data from the determined bullet screen pool;

the display module 93 is configured to sequentially displaying in a scrolling manner the selected character data in the current video time segment when the bullet screen data is the character data.

Preferably, the bullet screen data includes the user level and/or the sending date of the sender; the electronic device further includes:

an ordering module 94 configured to order the bullet screen data in the bullet screen pool by descending priority according to one or more of the sending date of the bullet screen data, the user level of the sender and the occurrence frequency of characters included before at most M entries of the bullet screen data is selected from the determined bullet screen pool, the occurrence frequency refers to the frequency at which the included characters occur in all bullet screen data of the video; and

the selection module 92 is specifically configured to select at most M entries of bullet screen data from the determined bullet screen pool.

Preferably, the electronic device further includes:

a marking module 95 configured to mark the bullet screen data displayed in a scrolling manner as displayed;

the selection module 92 is specifically configured to, for the current user, select at most M entries of the bullet screen data from the bullet screen data which are not marked as displayed in the determined bullet screen pool according to the ordering of the bullet.

Preferably, the electronic device further includes:

a speed determination module 96 configured to determine a corresponding moving speed of each entry of the selected bullet screen data according to the number of characters included in the bullet screen data after at most M entries of bullet screen data is selected from the determined bullet screen pool and before the selected bullet screen data is sequentially displayed in a scrolling manner within the current video time segment; where the more characters the bullet screen data include, the slower its moving speed is; and

the display module 93 is specifically configured to sequentially display in a scrolling manner the selected bullet screen data according to the determined corresponding moving speed in the current video time segment.

Preferably, the electronic device further includes:

a receiving module 97 configured to receive the bullet screen data sent by the current user at the current playing time;

an execution module 98 configured to add the received bullet screen data into the determined bullet screen pool, and take the current playing time point as the sending time of the received bullet screen data; and

a sending module 99 configured to send the received bullet screen data with the information including the video identifier of the video, a user level of the current user, the sending date, and the sending time to a bullet screen data server.

The display module 93 is specifically configured to, for the current user, sequentially display, in a scrolling manner, the selected bullet screen data and the received bullet screen data within the current video time segment.

Preferably, the marking module 95 is further configured to mark all bullet screen data in the bullet screen pool as not displayed when all the bullet screen data are displayed in the bullet screen pool corresponding to the video time segment.

Those skilled in the art can understand: all or parts of steps realizing the embodiments of the above-mentioned methods can be accomplished by hardware with regard to a program command, and the aforesaid process can be stored in a readable memory medium of a computer, the steps including the above-mentioned embodiments of the method are executed when the process is executed; the aforesaid memory medium includes: ROM, RAM, a disk or CD-ROM and other various mediums capable of storing program codes.

Lastly, it should be noted that all the above embodiments are only used for depicting the technical solution of the present application, rather than limiting; although the present application is depicted in details by reference to the aforesaid embodiments, those skilled in the art should understand: they can still amend the technical solutions recorded in all embodiments, or replace parts or all technical features therein equivalently; while those amendments or replacements will not make the nature of the corresponding technical solution out of the range of the technical solutions in all embodiments provided by the present application.

What is claimed is:

1. A method for displaying a bullet screen of a video, comprising:
creating a bullet screen layer including a transparent data layer and a transparent view layer between a video presentation layer of a video player and a user interface operating layer of the player, wherein the data layer is used for displaying characters, and the view layer is used for displaying images;
dividing acquired bullet screen data of the currently played video into a character bullet screen and an image bullet screen according to class identifiers included in the bullet screen data; and
sending the read character bullet screen to the data layer for display and the read image bullet screen to the view layer for display.

2. The method according to claim 1, wherein the creating the bullet screen layer including the transparent data layer and the transparent view layer between the video presentation layer and the player user interface operating layer comprises:
creating the transparent view layer between the video presentation layer and the user interface operating layer of the player; and
creating the transparent data layer between the created view layer and the user interface operating layer of the player.

3. The method according to claim 2, wherein the image bullet screen comprises image data, the playing time point of the video when the image bullet screen is sent, and the position on the video picture at which the image bullet screen is placed;
the sending the read image bullet screen to the view layer for display, comprises:
sending the read image bullet screen to the view layer;
creating, by the view layer, at least one image bullet screen pool according to a preset rule, and placing the image data of the read image bullet screen to the corresponding image bullet screen pool according to the playing time point of the video when the image bullet screen is sent;
displaying, by the view layer, the image data in the image bullet screen pool according to the position on the video picture at which the image bullet screen is placed;
the character bullet screen comprises: character data and the playing time point of the video when the character bullet screen is sent;
the sending the read character bullet screen to the data layer for display comprises:
sending the read character bullet screen to the data layer;
creating, by the data layer, at least one character bullet screen pool according to the preset rule, and placing the character data of the read character bullet screen into the corresponding character bullet screen pool according to the playing time point of the video when the character bullet screen is sent; and
displaying, by the data layer, in a scrolling manner character data in the character bullet screen pool.

4. The method according to claim 3, wherein the image bullet screen further comprises: the sending date of the image bullet screen, a user level of the sender and the density on the video picture; and creating, by the view layer, at least one image bullet screen pool according to the preset rule comprises:
creating, by the view layer, at least one image bullet screen pool corresponding to a video time segment according to the video time segment, wherein the playing time length of the video is divided to obtain a series of video time segments according to the preset division rule;
before image data of an image bullet screen in at least one image bullet screen pool are displayed by the view layer according to the position on the video picture at which the image bullet screen is placed, the method further comprises:
ordering, by the view layer, the image data in the image bullet screen pool by descending priority according to one or more of the sending date of the image bullet screen, the user level of the sender and the density on the video picture;
the displaying, by the view layer, the image data in the image bullet screen pool according to the position on the video picture at which the image bullet screen is placed, comprises:
displaying, by the view layer, the image data in the image bullet screen pool according to the ordering of the image data and the position on the video picture at which the image bullet screen is placed;
the creating, by the data layer, at least one character bullet screen pool according to the preset rule comprises:
creating, by the data layer, at least one character bullet screen pool corresponding to the video time segment according to the video time segment;
wherein the character bullet screen further comprises: the sending date of the character bullet screen, the user level of the sender and the occurrence frequency of characters included;
the occurrence frequency refers to the frequency at which the characters occur in all bullet screen data of the video; before the data layer displays in a scrolling manner the character data in the character bullet screen pool, the method further comprises:
ordering, the data layer, the character data in the character bullet screen pool by descending priority according to one or more of the sending date of the character bullet screen, the user level of the sender and the occurrence frequency of characters included; and
the displaying, by the data layer, the character data in the character bullet screen pool in a scrolling manner, comprises:
displaying, by the data layer, in a scrolling manner the character data in the character bullet screen pool according to the ordering.

5. The method according to claim 4, wherein displaying, by the data layer, in a scrolling manner the character data in the character bullet screen pool specifically comprises:
determining the bullet screen pool corresponding to the video time segment within which the current playing time point of the currently played video falls, wherein the playing time length of the video is divided to obtain a series of video time segments according to the preset rule, and the bullet screen pool comprises all bullet screen data sent by the user for the video within the corresponding video time segments during playback of the video;
acquiring a video pixel value of the currently played video, and determining the number of entries M of bullet screen data which are displayable during playback of the current video according to the correspondence between the stored video pixel value and the number of entries of the displayable bullet screen data;
selecting at most M entries of the bullet screen data from the determined bullet screen pool; and
sequentially displaying in a scrolling manner the selected character data during the current video time segment when the bullet screen data is the character data.

6. The method according to claim 5, wherein the selecting at most M entries of the bullet screen data from the determined bullet screen pool comprises:
selecting at most M entries of the bullet screen data from the determined bullet screen data pool according to the ordering of the bullet screen data.

7. The method according to claim 6, wherein the method further comprises: marking the bullet screen data which are displayed in a scrolling manner as displayed; and
the selecting at most M entries of the bullet screen data from the determined bullet screen pool according to the ordering of the bullet screen data, comprises:
for the current user, selecting at most M entries of the bullet screen data from the bullet screen data which are not marked as displayed of the determined bullet screen pool according to the ordering of the bullet screen data.

8. The method according to claim 5, wherein after at most M entries of the bullet screen data are selected from the determined bullet screen pool and before the selected bullet screen data are sequentially displayed in a scrolling manner during the current video time segment, the method further comprises:
determining a corresponding moving speed of each entry of the selected bullet screen data according to the number of characters included in the bullet screen data; wherein the more characters the bullet screen data comprises, the slower its moving speed is; and
the sequentially displaying in a scrolling manner the selected bullet screen data during the current video time segment, comprises:
sequentially displaying in a scrolling manner the selected bullet screen data at the corresponding determined moving speeds during the current video time segment.

9. The method according to claim 1, wherein the method further comprises:
receiving the image bullet screen sent by the current user at the current playing time, and recording the position on the video picture at which the image bullet screen is placed; and
setting the class identifier of the received image bullet screen as image, placing the image data in the received image bullet screen into the corresponding image bullet screen pool according to the current playing time, and sending the received image bullet screen with the information including a video identifier of the video, a user level of the current user, the sending date, the class identifier, the current playing time point and the position on the video picture at which the image bullet screen is placed to a bullet screen data server.

10. The method according to claim 1, wherein the method further comprises:
receiving the character bullet screen sent by the current user at the current playing time; and
setting class identifier of the received character bullet screen as character, placing the character data in the received character bullet screen into the corresponding character bullet screen pool according to the current playing time, and sending the received character bullet screen with the information including the video identifier of the video, the user level of the current user, the sending date, the class identifier and the current playing time point to the bullet screen data server.

11. An electronic device, comprising:
at least one processor; and
a memory communicably connected with the at least one processor for storing instructions executable by the at least one processor, wherein execution of the instructions by the at least one processor causes the at least one processor to:
create a bullet screen layer including a transparent data layer and a transparent view layer between a video presentation layer of a video player and a user interface operating layer of the player, wherein the data layer is used for displaying characters, and the view layer is used for displaying images;
divide acquired bullet screen data of the currently played video into a character bullet screen and an image bullet screen according to the class identifiers included in the bullet screen data; and
send the read character bullet screen to the data layer for display and the read image bullet screen to the view layer for display.

12. The electronic device according to claim 11, wherein the execution of the instructions by the at least one processor causes the at least one processor to: create the transparent view layer between the video presentation layer and the user interface operating layer of the player; and
create the transparent data layer between the created view layer and the user interface operating layer of the player.

13. The electronic device according to claim 12, wherein the image bullet screen comprises image data, the playing time point of the video when the image bullet screen is sent, and the position on the video picture at which the image bullet screen is placed; the character bullet screen comprises: character data and the playing time point of the video when the character bullet screen is sent; and
the execution of the instructions by the at least one processor causes the at least one processor to: send the read image bullet screen to the view layer; create, by using the view layer, at least one image bullet screen pool according to a preset rule, place the image data of the read image bullet screen to the corresponding image bullet screen pool according to the playing time point of the video when the image bullet screen is sent; display, by using the view layer, the image data in the image bullet screen pool according to the position on the video picture at which the image bullet screen is placed; send the read character bullet screen to the data layer;
create, by using the data layer, at least one character bullet screen pool according to a preset rule, and place the character data of the read character bullet screen into the corresponding character bullet screen pool according to the playing time point of the video when the character bullet screen is sent; and display, by using the data layer, in a scrolling manner the character data in the character bullet screen pool.

14. The electronic device according to claim 13, wherein the image bullet screen further comprises the sending date of the image bullet screen, a user level of the sender and the density on the video picture; the character bullet screen further comprises: the sending date of the character bullet screen, a user level of the sender and the occurrence frequency of characters included; the occurrence frequency refers to the frequency at which the characters occur in all bullet screen data of the video;
the execution of the instructions by the at least one processor causes the at least one processor to: create, by using the view layer, at least one image bullet screen pool corresponding to a video time segment according to the video time segment, wherein the playing time length of the video is divided to obtain a series of video time segments according to a preset division rule; and create, by using the data layer, at least one character bullet screen pool corresponding to the video time segment according to the video time segment;
order, by using the view layer, the image bullet screens in the image bullet screen pool by descending priority according to one or more of the sending date of the image bullet screen, the user level of the sender and the density on the video screen; and order, by using the data layer, the character data in the character bullet screen pool by descending priority according to one or more of the sending date of the character bullet screen, the user level of the sender and the occurrence frequency of characters included; and
display, by using the view layer, the image data in the image bullet screen pool according to the ordering of the image data and the position on the video picture at which the image bullet screen is placed; and display, by using the data layer, in a scrolling manner the character data in the character bullet screen pool according to the ordering.

15. The electronic device according to claim 14, wherein the execution of the instructions by the at least one processor causes the at least one processor to:
determine the bullet screen pool corresponding to the video time segment within which the current playing time point of the currently played video falls; wherein the playing time length of the video is divided to obtain a series of video time segments according to the preset rule; the bullet screen pool comprises all bullet screen data sent by the user for the video within the corresponding video time segments during playback of the video;
acquire a video pixel value of the currently played video, and determining the number of entries M of bullet screen data which are displayable during playback of the current video according to the correspondence between the stored video pixel value and the number of entries of the displayable bullet screen data; and
select at most M entries of bullet screen data from the determined bullet screen pool;
sequentially display in a scrolling manner the selected character data during the current video time segment when the bullet screen data is the character data.

16. The electronic device according to claim 15, wherein the execution of the instructions by the at least one processor causes the at least one processor to: select at most M entries of bullet screen data from the determined bullet screen pool according to the ordering of the bullet screen data.

17. The electronic device according to claim 16, wherein the execution of the instructions by the at least one processor further causes the at least one processor to:
mark the bullet screen data which are displayed in a scrolling manner as displayed; and
for the current user, select at most M entries of bullet screen data from the bullet screen data which are not marked as displayed in the determined bullet screen pool according to the ordering of the bullet screen data.

18. The electronic device according to claim 15, the execution of the instructions by the at least one processor further causes the at least one processor to:
determine a corresponding moving speed of each entry of the bullet screen data selected according to the number of characters included in the bullet screen data after at most M entries of bullet screen data are selected from the determined bullet screen pool and before the selected bullet screen data is sequentially displayed in a scrolling manner during the current video time segment; where the more characters the bullet screen data comprise, the slower its moving speed is; and
sequentially display in a scrolling manner the selected bullet screen data at the corresponding determined moving speed during the current video time segment.

19. A non-transitory computer-readable storage medium storing executable instructions that, when executed by an electronic device with a touch-sensitive display, cause the electronic device to:
create a bullet screen layer including a transparent data layer and a transparent view layer between a video presentation layer of a video player and a user interface operating layer of the player, wherein the data layer is used for displaying characters, and the view layer is used for displaying images;
divide acquired bullet screen data of the currently played video into a character bullet screen and an image bullet screen according to the class identifiers included in the bullet screen data; and
send the read character bullet screen to the data layer for display and the read image bullet screen to the view layer for display.

20. The non-transitory computer-readable storage medium according to claim 19, the stored executable instructions therein that, when executed by an electronic device with a touch-sensitive display, cause the electronic device to:
create the transparent view layer between the video presentation layer and the user interface operating layer of the player; and create the transparent data layer between the created view layer and the user interface operating layer of the player.
